(19) United States
(12) Patent Application Publication
(10) Pub. No.: US 2017/0167692 A1
(43) Pub. Date: Jun. 15, 2017

(54) BACKLIGHT MODULE

(71) Applicant: AU Optronics Corporation, HSIN-CHU (TW)

(72) Inventors: Wei-Chun CHUNG, HSIN-CHU (TW); Chi-Tang MA, HSIN-CHU (TW); Su-Yi LIN, HSIN-CHU (TW); Chih-Ling HSUEH, HSIN-CHU (TW)

(21) Appl. No.: 15/269,545

(22) Filed: Sep. 19, 2016

(30) Foreign Application Priority Data
Dec. 11, 2015 (TW) 104141647

(51) Int. Cl. F21V 7/10; F21V 7/05

(52) U.S. Cl. CPC F21V 7/10; F21V 7/05

(57) ABSTRACT

A backlight module includes a reflection base plate, at least one light source, at least one 3D optical control structure and a reflector. The light source is disposed on the reflection base plate. The 3D optical control structure is disposed on the reflection base plate and covers the light source. The 3D optical control structure includes a top surface and a lateral connected to the top surface. The lateral obliquely faces toward the reflection base plate, and an acute angle exists between the lateral and the reflection base plate. The reflector is disposed on the reflection base plate and beside the lateral. Light emitted from the light source passes through or is reflected by the top surface or the lateral, wherein a part of light passing through the lateral is reflected by the reflector so as to transmit toward a direction away from the reflection base plate.

### BACKGROUND

Technical Field

The present invention relates to a backlight module, and in particular, to a backlight module that can provide better optical quality.

Related Art

In recent years, as electronic products are popular, display panels for providing display functions in electronic products have become focuses being paid attention to by designers. There are many types of display panels, and they may be selected according to designs of electronic products. A part of types of display panels do not have light emitting function, and a backlight module needs to be configured under the display panel to provide a light source, thereby achieving the function of display.

The backlight module generally includes an assembly frame, a light source and a planar optical control board. According to relative relations between the light source and the planar optical control board, the backlight module may be classified into a direct type backlight module and a lateral type backlight module. By using the direct type backlight module as an example, a light source and a planar optical control board are configured in an assembly frame, where the light source is located under the planar optical control board, so that light emitted by the light source is guided by the planar optical control board, and a transmission direction or a distribution manner of the light emitted by the light source is adjusted and then the light is emitted out of the backlight module. The backlight module as the planar optical control board to adjust the transmission direction or distribution manner of the light; however, there are still some mura phenomena. Therefore, how to enable the backlight module to emit light with uniform brightness is always a target to be achieved in this field.

### SUMMARY

The present invention provides a backlight module, which can provide light with uniform brightness.

A backlight module of the present invention includes a reflection base plate, at least one light source, at least one 3D optical control structure and a reflector. The light source is disposed on the reflection base plate. The 3D optical control structure is disposed on the reflection base plate and covers the light source, each 3D optical control structure includes a top surface and a lateral connected to the top surface, where the lateral obliquely faces toward the reflection base plate, and an acute angle a exists between the lateral and the reflection base plate. The reflector is disposed on the reflection base plate and beside the lateral of the 3D optical control structure, where light emitted from the light source passes through the top surface or the lateral, or is reflected by the top surface or the lateral, where a part of light passing through the lateral is reflected by the reflector so as to transmit toward a direction away from the reflection base plate.

In an embodiment of the present invention, a base angle of the reflector contacting with the reflection base plate is an acute angle β, and a relation between the acute angle α and the acute angle β meets 2*(90°−α)−15°≦β≦2*(90°−α)+15°.

In an embodiment of the present invention, the backlight module includes two 3D optical control structures, the reflector is located between the two optical control structures, the reflector includes two base angles contacting with the reflection base plate, and the angles of the two base angles are the same or different.

In an embodiment of the present invention, the height of a joint of the lateral and the top surface relative to the reflection base plate is h1, the height of the reflector relative to the reflection base plate is h2, and h2≦h1.

In an embodiment of the present invention, the height of a joint of the lateral and the top surface relative to the reflection base plate is h1, the height of the reflector relative to the reflection base plate is h2, a distance between a positive projection of the joint of the lateral and the top surface on the reflection base plate and a positive projection of the highest point of the reflector on the reflection base plate is D, and the height h2 of the reflector relative to the reflection base plate meets

$$\frac{h 1 * tan α - D}{tan α} \leq h 2.$$

In an embodiment of the present invention, the backlight module includes two 3D optical control structures, the reflector is located between the two 3D optical control structures, and a distance between the reflector and one of the 3D optical control structures is the same as or different from a distance between the reflector and another one of the 3D optical control structures.

In an embodiment of the present invention, each of the 3D optical control structure and the reflector are respectively stripe-shaped structures, and the length of the reflector is equal to or less than the length of each of the 3D optical control structures.

In an embodiment of the present invention, the reflector is a triangular prism.

In an embodiment of the present invention, the reflectivity of the reflector is between 60% and 100%.

In an embodiment of the present invention, the reflector includes a surface facing toward the lateral of the at least one 3D optical control structure, and the surface includes a reflective coating, an ink layer, a rough layer, or a plurality of holes.

In an embodiment of the present invention, the backlight module further includes an optical film layer, located above the reflection base plate, the light source and the 3D optical control structure, the reflector including a surface facing toward the lateral of the at least one 3D optical control structure, and the surface of the reflector obliquely facing toward the optical film layer.

Based on the above, in the backlight module, the self-standing 3D optical control structure is disposed on the reflection base plate and covers the light source, without the need of supporting by using an additional spacer. The 3D optical control structure includes the top surface and the lateral connected to each other, the lateral obliquely faces toward the reflection base plate, the acute angle a exists between the lateral and the reflection base plate, and the reflector is disposed beside the lateral of the 3D optical control structure. A part of light emitted from the light source directly passes through the holes of the top surface of the 3D optical control structure, and a part of light passing through the lateral is reflected by the reflection base plate and the reflector to transmit toward a direction away from the reflection base plate, so that the light is distributed uniformly and will not be concentrated at the light source, thereby effectively achieving the objective of uniform backlight.

In order that the above features and advantages of the present invention are more comprehensible, embodiments are described in detail through the accompanying drawings in the following.

### BRIEF DESCRIPTION OF THE DRAWINGS

The disclosure will become more fully understood from the detailed description given herein below for illustration only, and thus are not limitative of the disclosure, and wherein:

FIG. 1 is a schematic partial sectional diagram of a backlight module according to an embodiment of the present invention;

FIG. 2 to FIG. 7 are real irradiation diagrams of light emitted from backlight modules not having a reflector and having reflectors with different base angles;

FIG. 8 is a line chart of a mura difference percentage of light emitted by backlight modules having reflectors with different base angles;

FIG. 9 is a schematic diagram of a 3D optical control structure and a reflector in the backlight module of FIG. 1;

FIG. 10 is a schematic three-dimensional diagram of the backlight module of FIG. 1;

and

FIG. 11 is a schematic three-dimensional diagram of a backlight module according to another embodiment of the present invention.

### DETAILED DESCRIPTION

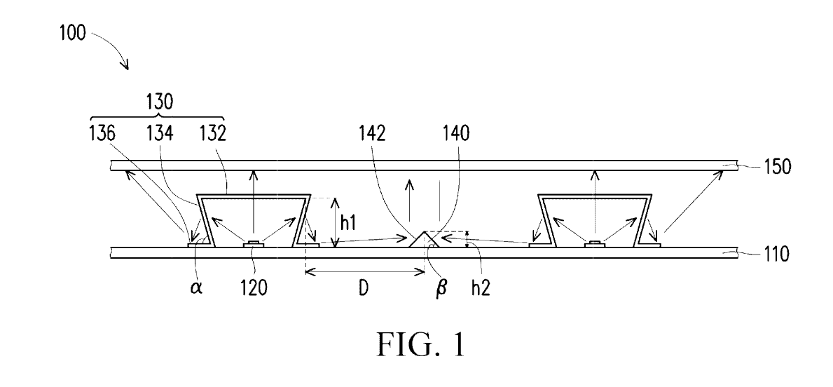

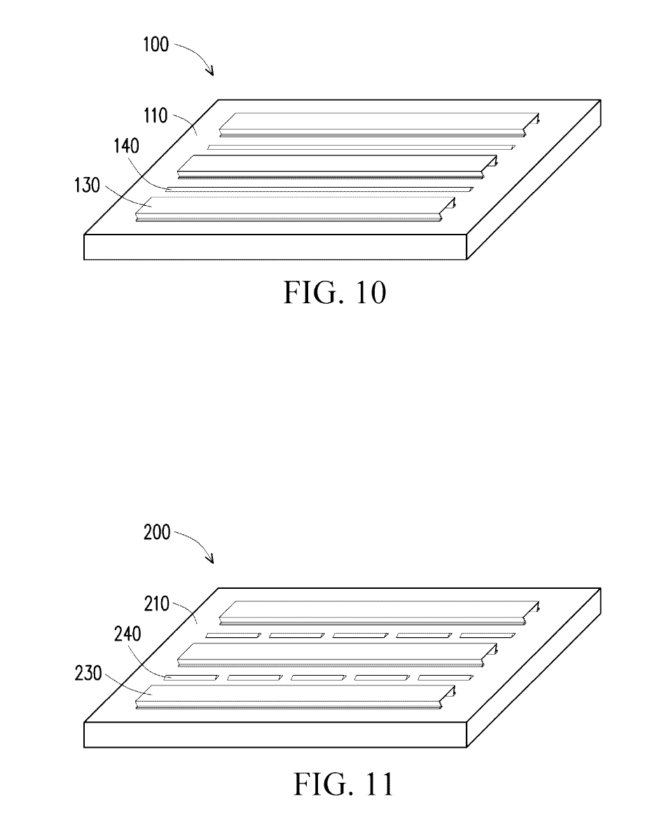

FIG. 1 is a schematic partial sectional diagram of a backlight module according to an embodiment of the present invention. Referring to FIG. 1, a backlight module 100 includes a reflection base plate 110, at least one light source 120, at least one 3D optical control structure 130, a reflector 140 and an optical film layer 150. In this embodiment, backlight module 100 includes a plurality of light sources 120, a plurality of 3D optical control structures 130 and a plurality of reflectors 140 (shown in FIG. 10). FIG. 1 merely schematically captures a local region having two light sources 120, two 3D optical control structures 130 and one reflector 140

As shown in FIG. 1, the light source 120 is disposed on the reflection base plate 110. In this embodiment, the light source 120 may be a light emitting diode or other suitable light sources. The 3D optical control structure 130 is disposed on the reflection base plate 110 and covers the light source 120. In this embodiment, seen from FIG. 1, each 3D optical control structure 130 includes a top surface 132, two laterals 134 connected to the top surface 132, and two bottom surfaces 136 respectively connected to the two laterals 134. The bottom surfaces 136 of the 3D optical control structure 130 are parallel to the reflection base plate 110 and are connected to the reflection base plate 110. The laterals 134 of the 3D optical control structure 130 obliquely face toward the reflection base plate 110, the two laterals 134 are symmetric to each other, and an acute angle α exists respectively between each of the laterals 134 and the reflection base plate 110. The top surface 132 of the 3D optical control structure 130 is parallel to the reflection base plate 110.

Definitely, the shape of the 3D optical control structure 130 is not limited thereto, and in other embodiments, the 3D optical control structure 130 may also omit the two bottom surfaces 136 parallel to the reflection base plate 110, the top surface 132 of the 3D optical control structure 130 may not be parallel to the reflection base plate 110, and the two laterals 134 of the 3D optical control structure 130 may not be symmetric and may form different angles with the reflection base plate 110. Designers may adjust the form of the 3D optical control structure 130 according to requirements.

It should be noted that, micropores on the 3D optical control structure 130 are not shown for simplicity of lines in the drawing, actually, in this embodiment, the 3D optical control structure 130 is a three-dimensional polyporous reflecting structure having high reflectivity, which can adjust the transmission direction and distribution manner of the light emitted from the light source. Specifically, the top surface 132 and the lateral 134 of the 3D optical control structure 130 have a plurality of micropores having different numbers or different areas, so that different regions of the top surface 132 have different light transmission amounts, and different regions of the lateral also have different light transmission amounts. For example, a region, above the corresponding light source 120, of the top surface 132 of the 3D optical control structure 130 has micropores having a smaller number or a smaller area, so as to allow a low light transmission amount. Oppositely, on another region, not corresponding to the light source 120, of the top surface 132 of the 3D optical control structure 130 has micropores having a greater number or a grater area, so as to provide a higher light transmission amount. Likewise, the lateral 134 of the 3D optical control structure 130 approaching a part being directly irradiated by the light emitted from the light source 120 has micropores having a smaller number or a smaller area, and the lateral 134 of the 3D optical control structure 130 away from the part being directly irradiated by the light emitted from the light source 120 has micropores having a greater number or a greater area. Therefore, the light emitted from the light source 120 can be adjusted by the 3D optical control structure 130 to adjust the distribution configuration thereof, and then be transmitted out, thereby improving the uniformity of the light.

In this embodiment, the 3D optical control structure 130 can stand on the reflection base plate 110 by its own structure, the 3D optical control structure 130 does not need to be supported by using an additional spacer. Compared with the conventional planar optical control board that is disposed above the light source and needs a plurality of spacers to maintain a distance therebetween, the backlight module 100 of this embodiment may omit the spacer, and therefore, cost for material and moulds can be saved. Moreover, the 3D optical control structure 130 of this embodiment further provides micropores of the lateral 134 to adjust light distribution of two sides near the light source 120.

In addition, the reflector 140 is disposed on the reflection base plate 110 and beside the lateral 134 of the 3D optical control structure 130. In this embodiment, the reflector 140 is located between two adjacent 3D optical control structures 130, the reflector 140 is a triangular prism, the reflector 140 includes two base angles (that is, the acute angles β) contacting with the reflection base plate 110 and two surfaces 142 respectively facing toward the laterals 134 of two 3D optical control structures 130. In this embodiment, the two base angles (that is, the acute angles β) of the reflector 140 have the same angle, in other words, the reflector 140 is an isosceles triangular prism; however, in other embodiments, the two base angles of the reflector 140 may be different, or, in other embodiments, the reflector 140 may be in other shapes, as long as it has a base angle being the acute angle β and a surface 142 facing toward the lateral 134 of the 3D optical control structure 130.

Moreover, in this embodiment, a distance between the reflector 140 and one of the 3D optical control structures 130 (for example, the 3D optical control structure 130 at the left side of FIG. 1) is the same as a distance between the reflector 140 and another one of the 3D optical control structures 130 (for example, the 3D optical control structure 130 at the right side of FIG. 1). However in other embodiments, the distance between the reflector 140 and one of the 3D optical control structures 130 may also be different from the distance between the reflector 140 and another one of the 3D optical control structures 130.

In this embodiment, the surface of the reflector 140 includes a reflective coating, which can be used to improve the reflectivity, and the reflectivity of the reflector 140 is between 60% and 100%. In other embodiments, if the reflectivity of the reflector 140 is high, the surface of the reflector 140 may further include an ink layer or a plurality of holes, and the reflectivity may be adjusted by the ink layer or the holes to a required range. In addition, in other embodiments, the surface of the reflector 140 may also include a rough layer, and the reflector 140 may diffuse the reflected light in various directions.

The optical film layer 150 is located above the reflection base plate 110, the light source 120 and the 3D optical control structure 130, and the surface of the reflector 140 also obliquely faces toward the optical film layer 150. The optical film layer 150 is, for example, a prism film, a diffusion film, a brightness enhancement film (BEF), a polarizer film, and the like, so as to adjust the transmission direction or distribution manner of the light emitted from the light source 120. In other embodiments, the design of the optical film layer 150 may also be omitted.

In this embodiment, the light emitted from the light source 120 passes through the top surface 132 or lateral 134 of the 3D optical control structure 130, or is reflected by the top surface 132 or lateral 134, where a part of light passing through the lateral 134 is reflected by the reflector 140 to transmit toward a direction away from the reflection base plate 110. Specifically, a part of light emitted from the light source 120 directly passes through the micropores on the top surface 132 or lateral 134 of the 3D optical control structure 130 and then transmits toward the direction of the optical film layer 150, a part of light that does not pass through the top surface 132 of the 3D optical control structure 130 is reflected by the top surface 132 and then passes through the lateral 134, and this part of light passing through the lateral 134 is then reflected by the reflection base plate 110 and the reflector 140 to transmit toward the direction away from the reflection base plate 110, so that the light is distributed uniformly and will not concentrate at the light source 120, thereby effectively achieving the objective of uniform backlight.

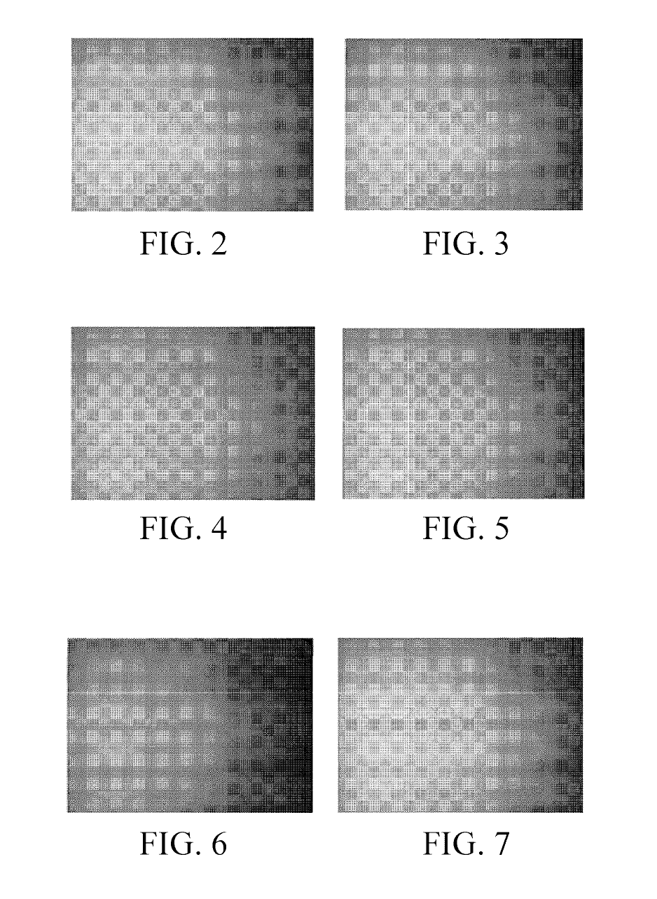

The disposition of the reflector 140 enables that the light can be mixed more uniformly, thereby reducing the degree of mura. In the following, actual photos are used to describe states of light emitted by backlight modules not having a reflector 140 and having reflectors 140 with different base angles. FIG. 2 to FIG. 7 are respectively real irradiation diagrams of light emitted from backlight modules not having a reflector and having reflectors with different base angles.

Referring to FIG. 2 to FIG. 7, in the backlight module of FIG. 2 to FIG. 7, a base angle between the lateral 134 and reflection base plate 110 of the 3D optical control structure 130 (that is, the acute angle α in FIG. 1) is, for example, 75 degrees. The backlight module of FIG. 2 omits the reflector 140 of FIG. 1, and the reflectors 140 of the backlight modules in FIG. 3 to FIG. 7 have base angles (that is, the acute angle β) respectively being 15 degrees, 30 degrees, 45 degrees, 60 degrees and 75 degrees. It can be seen from FIG. 2 to FIG. 7 that, compared with the backlight module not having the reflector 140, the backlight module 100 having the reflector 140 disposed on the reflection base plate 110 and beside the lateral 134 of the 3D optical control structure 130 has preferred light uniformity.

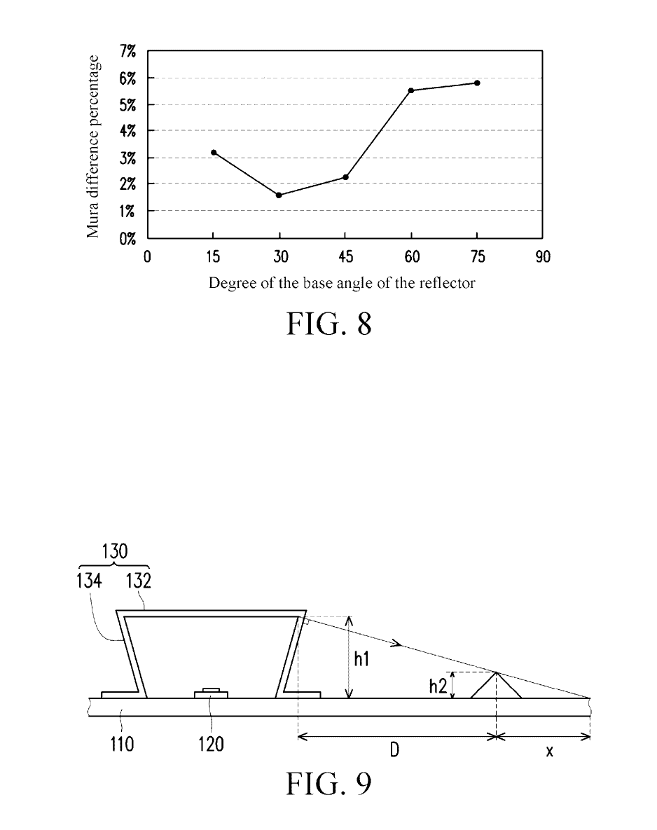

FIG. 8 is a line chart of a mura difference percentage of light emitted by backlight modules having reflectors with different base angles. FIG. 8 is a line chart showing mura difference percentages drawn according to experiment results of FIG. 3 to FIG. 7. Referring to FIG. 8, it can be clearly seen from FIG. 8 together with FIG. 3 to FIG. 7 that, in the promise that the base angle between the lateral 134 and the reflection base plate 110 of the 3D optical control structure 130 (that is, the acute angle α in FIG. 1) is 75 degrees, the base angle of the reflector 140 of the backlight module 100 (that is, the acute angle β) ranges preferably from 15 degrees to 45 degrees. More specifically, the base angle of the reflector 140 of the backlight module 100 (that is, the acute angle β) ranges preferably at 30 degrees, and light emitted by this backlight module 100 has the optimal light mixing effect.

Merely a part of experiment results are illustrated, and it can be known from experiment results obtained by adjusting different angles for many times, if the base angle of the reflector 140 contacting with the reflection base plate 110 is the acute angle β, a relationship between the base angle between the lateral 134 of the 3D optical control structure 130 and the reflection base plate 110 (that is, the acute angle α in FIG. 1) and the base angle of the reflector 140 contacting with the reflection base plate 110 (that is, the acute angle β) meets 2*(90°−α)−15°≦β≦2* (90°−α)+15°, and a preferred light mixing effect may be achieved.

Moreover, in addition to the angle relationship between the reflector 140 and the 3D optical control structure 130, the height of the reflector 140 and a distance between the reflector 140 and the 3D optical control structure 130 also need to be discussed.

FIG. 9 is a schematic diagram of a 3D optical control structure and a reflector of the backlight module in FIG. 1. Referring to FIG. 9, in this embodiment, the height of a joint of the lateral 134 and the top surface 132 of the 3D optical control structure 130 relative to the reflection base plate 110 is h1, the height of the reflector 140 relative to the reflection base plate 110 is h2, a distance between a positive projection of the joint of the lateral 134 and the top surface 132 on the reflection base plate 110 and a positive projection of the highest point of the reflector 140 on the reflection base plate 110 is D. It can be seen from FIG. 9 that, if it is intended that light vertically emitted out of the lateral 134 from the highest position of the lateral 134 of the 3D optical control structure 130 can be reflected by the reflector 140, the light at least passes through the highest point of the reflector 140. A distance between the highest point of the reflector 140 to an intersection at which the light is irradiated to the reflection base plate 110 is set to x, and two similar triangles having the same angles will appear in FIG. 9, base edges of the two similar triangles are respectively x and x+D, and it can be obtained through deduction according to the proportion of the similar triangles, the height h2 of the reflector 140 relative to reflection base plate 110 meets

$$\frac{h 1 * tan α - D}{tan α} \leq h 2.$$

In another embodiment, if h2 is too high, a range of the reflector that cannot reflect the light vertically emitted out of the lateral 134 from the highest position of the lateral 134 of the 3D optical control structure 130 becomes lager, and the distance approaching the optical film layer 150 becomes smaller, which easily causes a dark shadow of the reflector 140 on a frame, and therefore, in a preferred design, it may be further defined that h2≦h1, that is

$$\frac{h 1 * tan α - D}{tan α} \leq h 2 \leq h 1.$$

FIG. 10 is a schematic three-dimensional diagram of the backlight module in FIG. 1. It should be noted that, FIG. 10 mainly shows a position relationship between the reflector 140 and the 3D optical control structure 130, and therefore, the optical film layer 150 is hidden in the FIG. 10, so that the reflector 140 and the 3D optical control structure 130 can be directly viewed from the above viewing angle. Referring to FIG. 10, it can be clearly seen from FIG. 10 that, the reflector 140 is disposed between two 3D optical control structures 130, and a distance between each reflector 140 and the 3D optical control structures 130 at two sides is the same. Each 3D optical control structure 130 and the reflector 140 are respectively stripe-shaped structures, an extension direction of the reflector 140 is parallel to the 3D optical control structure 130, and the length of the reflector 140 is equal to the length of each of the 3D optical control structures 130. Definitely, the configuration relationship between the reflector 140 and the 3D optical control structure 130 is not limited thereto.

FIG. 11 is a schematic three-dimensional diagram of a backlight module according to another embodiment of the present invention. Referring to FIG. 11, a difference between a backlight module 200 of FIG. 11 and the backlight module 100 of FIG. 10 mainly lies in that, in FIG. 11, the length of the reflector 240 is less than the length of the nearby 3D optical control structure 230. In other words, there may be a plurality of reflectors 240 arranged into a row along the same axis beside the 3D optical control structure 230.

Moreover, although the 3D optical control structure 130, 230 and the reflector 140, 240 are arranged on the reflection base plate 110, 210 along a long edge direction of the reflection base plate 110, 210, in other embodiments, the 3D optical control structure 130, 230 and the reflector 140, 240 may also be arranged on the reflection base plate 110, 210 along a short edge direction of the reflection base plate 110, 210, and the arrangement manners of the reflector 140 and the 3D optical control structure 130 on the reflection base plate 110 are not limited in the drawings.

In view of the above, in the backlight module of the present invention, the self-standing 3D optical control structure is disposed on the reflection base plate and covers the light source, without the need of supporting by using an additional spacer. The 3D optical control structure includes the top surface and the lateral connected to each other, the lateral obliquely faces toward the reflection base plate, the acute angle a exists between the lateral and the reflection base plate, and the reflector is disposed beside the lateral of the 3D optical control structure. A part of light emitted from the light source directly passes through the holes of the top surface of the 3D optical control structure, and a part of light passing through the lateral is reflected by the reflection base plate and the reflector to transmit toward a direction away from the reflection base plate, so that the light is distributed uniformly and will not be concentrated at the light source, thereby effectively achieving the objective of uniform backlight.

The present invention has been disclosed in the foregoing embodiments; however, the embodiments are not intended to limit the present invention, and any persons of ordinary skill in the art can make some modifications and improvements without departing from the spirit and scope of the present invention; therefore, the protection scope of the present invention should subject to those defined in the accompanying claims.

What is claimed is:

1. A backlight module, comprising:
a reflection base plate;
at least one light source, disposed on the reflection base plate;
at least one 3D optical control structure, disposed on the reflection base plate and covering the at least one light source, each 3D optical control structure comprising a top surface and a lateral connected to the top surface, wherein the lateral obliquely faces toward the reflection base plate, and an acute angle a is formed between the lateral and the reflection base plate; and
a reflector, disposed on the reflection base plate and beside the lateral of the at least one 3D optical control structure, wherein light emitted from each light source passes through the top surface or the lateral of the corresponding 3D optical control structure, or is reflected by the top surface or the lateral, wherein a part of light passing through the lateral is reflected by the reflector so as to transmit toward a direction away from the reflection base plate.

2. The backlight module according to claim 1, wherein a base angle of the reflector contacting with the reflection base plate is an acute angle β, and a relation between the acute angle α and the acute angle β meets 2*(90°−α)−15°≦β≦2*(90°−α)+15°.

3. The backlight module according to claim 1, wherein the backlight module comprises two 3D optical control structures, the reflector is located between the two 3D optical control structures, the reflector comprises two base angles contacting with the reflection base plate, and the two base angles are same.

4. The backlight module according to claim 1, wherein the backlight module comprises two 3D optical control structures, the reflector is located between the two 3D optical control structures, the reflector comprises two base angles contacting with the reflection base plate, and the two base angles are different.

5. The backlight module according to claim 1, wherein the height of a joint of the lateral and the top surface relative to the reflection base plate is h1, the height of the reflector relative to the reflection base plate is h2, a distance between a positive projection of the joint of the lateral and the top surface on the reflection base plate and a positive projection of the highest point of the reflector on the reflection base plate is D, and the height h2 of the reflector relative to the reflection base plate meets
$$\frac{h 1 * tan α - D}{tan α} \leq h 2.$$

6. The backlight module according to claim 5, wherein the height h1 of the joint of the lateral and the top surface relative to the reflection base plate and the height h2 of the reflector relative to the reflection base plate meet h2≦h1.

7. The backlight module according to claim 1, wherein the backlight module comprises two 3D optical control structures, the reflector is located between the two 3D optical control structures, and a first distance between the reflector and one of the 3D optical control structures is same a second distance between the reflector and another one of the 3D optical control structures.

8. The backlight module according to claim 1, wherein the backlight module comprises two 3D optical control structures, the reflector is located between the two 3D optical control structures, and a first distance between the reflector and one of the 3D optical control structures is different from a second distance between the reflector and another one of the 3D optical control structures.

9. The backlight module according to claim 1, wherein each of the 3D optical control structure and the reflector are stripe-shaped structures, and a length of the reflector is equal to or less than the length of each of the 3D optical control structures.

10. The backlight module according to claim 1, wherein the reflector is a triangular prism.

11. The backlight module according to claim 1, wherein the reflectivity of the reflector is between 60% and 100%.

12. The backlight module according to claim 1, wherein the reflector comprises a surface facing toward the lateral of the at least one 3D optical control structure, and the surface comprises a reflective coating, an ink layer, a rough layer, or a plurality of holes.

13. The backlight module according to claim 1, further comprising:
an optical film layer, located above the reflection base plate, the light source and the at least one 3D optical control structure, the reflector comprising a surface facing toward the lateral of the at least one 3D optical control structure, and the surface of the reflector obliquely facing toward the optical film layer.
